(19) United States
(12) Patent Application Publication
(10) Pub. No.: US 2021/0279338 A1
(43) Pub. Date: Sep. 9, 2021

(54) GRAPH-BASED SOURCE CODE VULNERABILITY DETECTION SYSTEM

(71) Applicant: The George Washington University, Washington, DC (US)

(72) Inventors: Benjamin Bowman, Kensington, MD (US); H. Howie Huang, McLean, VA (US)

(21) Appl. No.: 17/192,249

(22) Filed: Mar. 4, 2021

Related U.S. Application Data
(60) Provisional application No. 62/985,145, filed on Mar. 4, 2020.

(51) Int. Cl. G06F 21/57; G06F 8/75; G06F 8/71; G06F 16/901

(52) U.S. Cl. CPC G06F 21/577; G06F 8/75; G06F 2221/033; G06F 16/9024; G06F 8/71

(57) ABSTRACT

The graph-based source code vulnerability detection system that uses a code-similarity style technique to identify highly modified vulnerable code clones while remaining generic to all vulnerability types. The system abstracts vulnerabilities in source code to the graph domain, allowing it to identify key relationships between textual elements that are not directly discernible from the text alone. Additionally, the system analyzes the patched code in addition to the vulnerable code to identify specific relationships in the graph that are tied directly to the vulnerable code segment, the patched code segment, and the contextual code of a particular vulnerability. By separating the vulnerability representation into these three components, a matching algorithm identifies vulnerable code clones while tolerating modifications at each level independently, providing more robust detection of modified vulnerable code clones.

### CROSS-REFERENCE TO RELATED APPLICATIONS

This application claims priority to U.S. Prov. Pat. Appl. No. 62/985,145, filed Mar. 4, 2020, which is hereby incorporated by reference.

### FEDERAL FUNDING

This invention was made with government support from the Defense Advanced Research Projects Agency (under agreement number N66001-18-C-4033) and the National Science Foundation (CAREER award 1350766 and grants 1618706 and 1717774). The government has certain rights in the invention.

### BACKGROUND

Software vulnerabilities are a common attack vector for cyber adversaries. In 2019, there were over 17,000 new vulnerabilities published in the National Vulnerability Database (NVD). In 2015-2019, there were over 60,000 new additions into the NVD, including the vulnerability exploited in the high-profile Equifax hack of 2017, which exposed personal data of over 145 million Americans.

Software vulnerabilities are exacerbated by the wealth of open-source software projects, which allow for the open distribution and reuse of computer software. The purpose of open-source software projects is to allow code segments to be copied and pasted to new locations. Unfortunately, this leads to an increase in vulnerable code clones, which occur when unknowingly vulnerable code is copied from one location and pasted to another. When the vulnerability is discovered and patched, there is no guarantee that all occurrences of that vulnerability in all other locations within and across various projects and versions are patched as well. This means the source code with the vulnerable code clones will likely go unpatched, leaving them at risk for malicious exploitation.

Discovering vulnerable code reuse in source code is known as vulnerable code clone detection. This is a very challenging problem as the cloned code has the potential to be modified (sometimes significantly) from the original code while still retaining the underlying vulnerability. Existing vulnerable clone detection techniques are either too strict, missing vulnerabilities when they have subtle modifications, or are too narrow, applicable only to a small number of vulnerability types.

Existing techniques for detecting vulnerable code clones fall into two main categories: code similarity and functional similarity. In code similarity approaches, the target source code is compared against a set of known vulnerable code samples and determined to be vulnerable if a threshold of similarity is met. Code similarity approaches are typically classified based on four types of detection coverage: identical (type-1), syntactically equivalent (type-2), syntactically similar (type-3), and semantically similar (type4). Existing code similarity techniques perform well when detecting identical (type-1) or syntactically equivalent (type-2) code clones, but suffer when the code has increased modification, such as the addition and deletion of lines of code (type-3 and type-4).

Functional similarity approaches, on the other hand, seek to generate abstract functional patterns of code that model vulnerable behavior. If the functional patterns are simple, the techniques suffer from low accuracy and generate many false positives. Conversely, if the functional patterns are complex, they have the capability to identify vulnerable code clones with significant modifications. However, due to the complexity of building such a pattern, these techniques are typically specialized to only a small class of vulnerabilities or to a particular source code project, rendering them ineffective as general-purpose vulnerable code clone detection techniques.

Existing techniques for detecting vulnerable code clones often fail, as they are either too strict (covering only identical or near-identical code clones) or too narrow (spanning only a few vulnerability classes or source code projects). Therefore, in a time when we rely on computer software our in our personal and professional lives as well as critical infrastructure, there is a need for an improved method of identifying vulnerabilities in source code before they are exploited by cyber adversaries.

### SUMMARY

The disclosed graph-based source code vulnerability detection system uses a code-similarity style technique to identify highly modified vulnerable code clones while remaining generic to all vulnerability types. The system abstracts vulnerabilities in source code to the graph domain, allowing it to identify key relationships between textual elements that are not directly discernible from the text alone. Additionally, the system analyzes the patched code in addition to the vulnerable code to identify specific relationships in the graph that are tied directly to the vulnerable code segment, the patched code segment, and the contextual code of a particular vulnerability. By separating the vulnerability representation into these three components, a matching algorithm identifies vulnerable code clones while tolerating modifications at each level independently, providing more robust detection of modified vulnerable code clones.

### BRIEF DESCRIPTION OF THE DRAWINGS

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings.

FIG. 1 is a diagram illustrating the architecture of the source code vulnerability detection system according to an exemplary embodiment.

FIG. 2 is a block diagram illustrating the source code vulnerability detection system according to an exemplary embodiment.

FIG. 3 illustrates an example code property graph for a code segment according to an exemplary embodiment.

FIG. 4A shows an example of a type-3 code clone of vulnerable source code.

FIG. 4B shows an example of a type-3 code clone of patched source code.

FIG. 4C shows another, more complex type-3 code clone of vulnerable source code.

FIG. 4D shows the more complex type-3 code clone of patched source code.

### DETAILED DESCRIPTION

In describing the illustrative, non-limiting embodiments illustrated in the drawings, specific terminology will be resorted to for the sake of clarity. However, the disclosure is not intended to be limited to the specific terms so selected, and it is to be understood that each specific term includes all technical equivalents that operate in similar manner to accomplish a similar purpose. Several embodiments are described for illustrative purposes, it being understood that the description and claims are not limited to the illustrated embodiments and other embodiments not specifically shown in the drawings may also be within the scope of this disclosure.

A vulnerability in source code can be defined as any weakness of the code which can be exploited to perform unauthorized actions. For example, Code Segment 1 shows a synthetic function foo with a vulnerability:

[Code Segment 1]

| | |
|---|---|
| 1 | void foo( ) { |

| | |
|---|---|
| 2 | int x = intput( ); |
| 3 | if (x > MIN) { |

| | |
|---|---|
| 4 | int y = x * 10; |
| 5 | output(y); |

| | |
|---|---|
| 6 | } |

| | |
|---|---|
| 7 | } |

Code Segment 2 shows the same synthetic function foo after the vulnerability was patched:

[Code Segment 2]

| | |
|---|---|
| 1 | void foo( ) { |

| | |
|---|---|
| 2 | int x = intput( ); |
| 3 | if (x > MIN) { |

| | |
|---|---|
| 4 | int y = x * 10; |
| 5 | if (y < MAX) |

| | |
|---|---|
| 6 | output(y); |

| | |
|---|---|
| 7 | } |

| | |
|---|---|
| 8 | } |

Both versions of the foo function read some input into a variable x on line 2. Then, both compare that input value against some variable MIN and, if x is larger than MIN, they both proceed inside the conditional statement. Both versions then perform some transformation of x into the variable y. In the vulnerable version of foo (Code Segment 1), the value of y is simply passed to the output function. In the patched version of foo (Code Segment 2), however, the value of y is first compared against some variable MAX, and is only passed to the output function provided that y is less than MAX. Based on both the vulnerable version and the patch version of the function, we can infer that the function output is only defined on values less than MAX and is not safe to use with values above that limit. Thus, the vulnerability in this case was the omitted upper bounds check on the value passed to the function output.

To compare the coverage of code clone detection techniques, we use the following standard clone type taxonomy:
Type-1: Identical code except changes to whitespace and comment lines.
Type-2: Syntactically identical code with modifications to identifiers, literals, types, whitespace, and comments.
Type-3: Syntactically similar code with addition and/or deletion of lines, as well as modification to identifiers, literals, types, whitespace, and comments.
Type-4: Syntactically different code with the same functionality (i.e., semantically similar)

An example of a type-1 code clone is shown in Code Segment 3, in which a single comment line is added on line 2:

[Code Segment 3]

| | |
|---|---|
| 1 | void foo( ) { |

| | |
|---|---|
| 2 | //comment line |
| 3 | int x = intput( ); |
| 4 | if (x > MIN) { |

| | |
|---|---|
| 5 | int y = x * 10; |
| 6 | output(y); |

| | |
|---|---|
| 7 | } |

| | |
|---|---|
| 8 | } |

An example of a type-2 code clone is shown in Code Segment 4, in which the bounds check variable MIN has been renamed minimum on line 3:

[Code Segment 4]

| | |
|---|---|
| 1 | void foo( ) { |

| | |
|---|---|
| 2 | int x = intput( ); |
| 3 | if (x > minimum) { |

| | |
|---|---|
| 4 | int y = x * 10; |
| 5 | output(y); |

| | |
|---|---|
| 6 | } |

| | |
|---|---|
| 7 | } |

An example of a type-3 code clone is shown in Code Segment 5, which defines an additional variable z and initializes it to the value of x on line 4:

[Code Segment 5]

| | |
|---|---|
| 1 | void foo( ) { |

| | |
|---|---|
| 2 | int x = intput( ); |
| 3 | if (x > MIN) { |

| | |
|---|---|
| 4 | int z = x; |
| 5 | int y = x * 10; |
| 6 | output(y); |

| | |
|---|---|
| 7 | } |

| | |
|---|---|
| 8 | } |

An example of a type-4 code clone is shown in Code Segment 6, which replaces the y=x*10 multiplication statement with a series of ten addition operations on lines 5-7:

[Code Segment 6]

| | |
|---|---|
| 1 | void foo( ) { |

| | |
|---|---|
| 2 | int x = intput( ); |
| 3 | if (x > MIN) { |

| | |
|---|---|
| 4 | int y=0; |
| 5 | for(int i=0;i<10;i++){ |

| | |
|---|---|
| 6 | y=y+x |

| | |
|---|---|
| 7 | } |
| 8 | output(y); |

| | |
|---|---|
| 9 | } |

| | |
|---|---|
| 10 | } |

Note that each of the Code Segments 3-6 represents a pure clone, meaning it only has the modification most associated with each type. However, based on the definitions, each clone type can also include the modifications associated with the types below it. For example, the type-3 code clone shown in Code Segment 5 may also rename the variable MIN as minimum and it would still be considered a type-3 clone.

Type 1-3 clones can be thought of as clones which are textually similar, while type-4 clones are functionally similar. The related works can be broadly categorized based on these two similarity measures.

When vulnerabilities are discovered in software, they typically go through a process where they are assigned a Common Vulnerability Enumeration (CVE) identifier. A CVE identifier uniquely identifies the instance of a particular vulnerability and is tied to specific versions of a software product. Additionally, CVEs are associated with Common Weakness Enumeration (CWE) identifiers, which represent different classes of vulnerabilities, such as improper input validation (CWE-200), out-of-bounds read (CWE-125), and use-after-free (CWE-416).

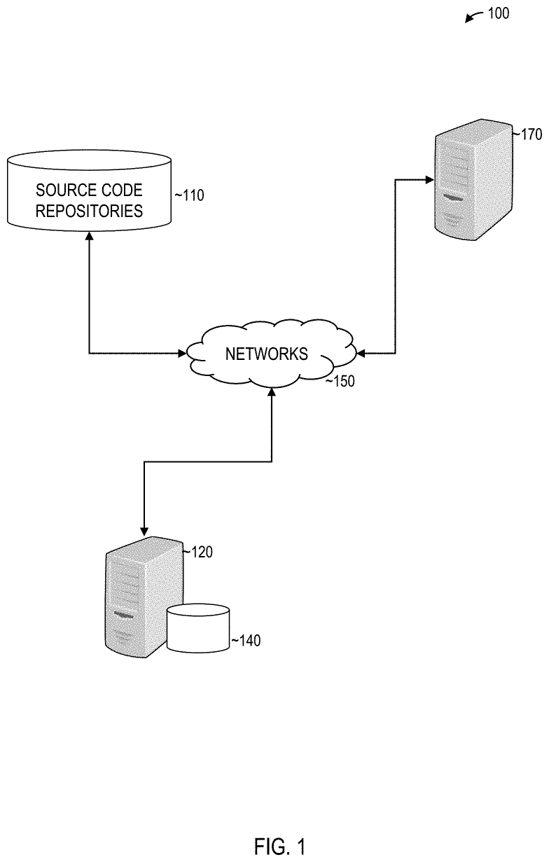

FIG. 1 is a diagram illustrating the architecture 100 of the source code vulnerability detection system according to an exemplary embodiment.

As shown in FIG. 1, the architecture 100 may include a server 120 and storage media 140 in communication with one or more source code repositories 110 and a target system 170 via one or more networks 150.

The server 120 may be any computing device capable of performing the functions described herein. The server 120 includes at least one hardware processor and (non-transitory) memory that stores instructions that, when executed by the at least one hardware processor, cause the server 120 to perform the functions described herein. The storage media 140 may include any number of non-transitory computer-readable storage mediums. The storage media 140 may be internal to the server 120 or external to the server 120 (e.g., in communication with the server 120 via a wired connection or local area network).

The networks 150 may include any combination of the internet, cellular networks, wide area networks (WAN), local area networks (LAN), etc. Communication via the networks 150 may be realized by wired and/or wireless connections.

The one or more source code repositories 110 may be any collection of source code that is publicly available via the networks 150. The one or more source code repositories 110 may include, for example, GitHub.

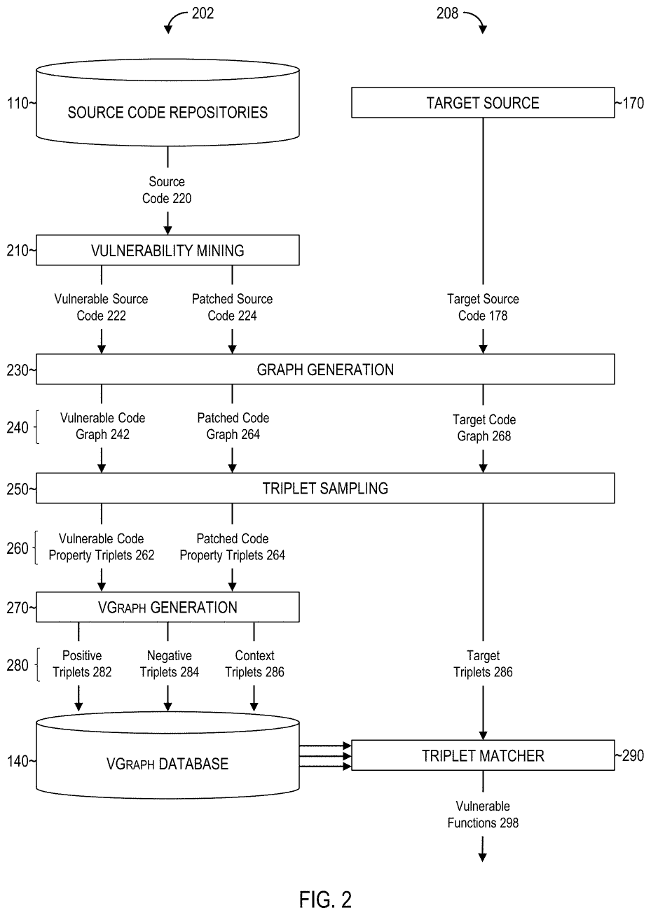

The target system 170 includes a target source code 178 (identified in FIG. 2) that is evaluated by the source code vulnerability detection system to identify if the target source code 178 likely includes a vulnerability. The target system 170 be, for example, a web server, an application server, etc.

FIG. 2 is a block diagram illustrating the source code vulnerability detection system 200 according to an exemplary embodiment.

As shown in FIG. 2, the source code vulnerability detection system 200 performs a vulnerability detection process in two distinct phases: a generation phase 202 and a detection phase 208. Both the generation phase 202 and the detection phase 208 may be performed, for example, by the server 120.

The source code vulnerability detection system 200 includes a vulnerability mining module 210, a graph generation module 230, a triplet sampling module 250, a vulnerability graph (“VGraph”) generation module 270, and a triplet matching module 290. Each of the vulnerability mining module 210, the graph generation module 230, the triplet sampling module 250, the vulnerability graph generation module 270, and the triplet matching module 290 may be realized by software instructions stored in memory by the server 120 and executed by the hardware processor of the server 120.

The vulnerability mining module 210 mines the one or more source code repositories and acquires source code 220, including samples of both vulnerable source code 222 and patched source code 224. Each sample of vulnerable source code 222 is paired with a sample patched source code 224 in which the vulnerability was patched. In some embodiments, the vulnerability mining module 210 may provide functionality for a user to manually generate a dataset of vulnerable source code 222 and patched source code 224. However, in those embodiments, the source code vulnerability detection system 200 is only able to model and detect a small number of programs and/or vulnerability types. In addition, there is likely some bias introduced on behalf of the user as to what samples are added to the dataset of vulnerable source code 222.

Therefore, in preferred embodiments, the vulnerability mining module 210 performs an automated process to collect samples of vulnerable source code 222, allowing the source code vulnerability detection system 200 to model and detect a wide range of programs and vulnerability types. Only when the dataset of vulnerable source code 222 is sufficiently large is any code-similarity-based technique be able to keep up with the continuous flow of new and diverse vulnerabilities.

As briefly mentioned above, each source code repository 110 preferably includes a version control system that allows multiple versions of the same source code to be uploaded. Version control software is widely utilized by software developers to manage and track changes to source code. Each operation that sends the latest changes to source code to the repository is commonly referred to as a “commit.” Version control systems generally include log messages (commonly referred to as “commit logs”), which provide fine-grained and detailed information regarding what changed in the code, when, and why.

The vulnerability mining module 210 may download vulnerable source code 222 and patched source code 224 by identifying source code 220 with log messages that reference a vulnerability (e.g., by CVE number) and downloading the source code 220 from before and after a change was made to patch the identified vulnerability. For example, the vulnerability mining module 210 may first identify log messages that include the string “CVE-20”, for example using the git command git log—grep=“CVE-20” on GitHub. Next, the vulnerability mining module 210 may identify the files, functions, and locations of source code additions, deletions, and modifications associated with the log message that includes the string referencing the vulnerability. Having identified source code files 220 that contain an original vulnerable version 222 and a patched version 224, the vulnerability mining module 210 downloads the original, vulnerable source code 222 and the patched source code 224. Additionally, the vulnerability mining module 210 may parse the vulnerable source code 222 and the patched source code 224, determine if the modifications to patch the vulnerability occurred inside a specific function, and identify the specific function of interest. As a result, the vulnerability mining module 210 downloads vulnerable source code 222 samples, each paired with a patched source code 224 sample, both associated with a particular vulnerability.

The graph generation module 230 generates code property graphs 240 of the vulnerable source code 222 and the patched source code 224 downloaded by the vulnerability mining module 210.

A code property graph 240 is a multigraph containing the representative nodes and edges from an abstract syntax tree, a control flow graph, and a program dependence graph. More specifically, the code property graphs 240 generated by the graph generation module 230 are directed, edge-labeled, attributed multigraphs of the form G=(V, E, λ, μ) where Visa set of nodes, E is a set of directed edges, A is an edge labeling function, and μ is a node property labeling function. The code property graphs 240 may be generated, for example, using the open source tool Joern.

An abstract syntax tree is a tree representation of the abstract syntactic structure of source code. The abstract syntax tree serves as the foundation of the code property graph 240, decomposing the source code into various language constructs, such as a ForStatement, a Symbol, a CallExpression, etc. These different types of constructs define the node types of the code property graph 240. Additional node types may include, for example, IdentifierDecl Statement, ReturnType, EqualityExpression, CompoundStatement, DeclStmt, PostlncDecOperationExpression, IfStatement, IdentifierDecl, Parameter, ClassDefStatement, ReturnStatement, CastTarget, BitAndExpression, IncDec, AssignmentExpression, ExpressionStatement, PrimaryExpression, InclusiveOrExpression, WhileStatement, IdentifierDeclType, UnaryOperator, Forinit, CFGExitNode, CFGEntryNode, PtrMemberAccess, ConditionalExpression, GotoStatement, BreakStatement, ArgumentList, MemberAccess, UnaryExpression, DoStatement, Callee, CastExpression, ParameterType, SizeofExpression, Sizeof, ShiftExpression, Arraylndexing, ElseStatement, UnaryOperationExpression, Expression, InitializerList, MultiplicativeExpression, ContinueStatement, Statement, Argument, OrExpression, AndExpression, Identifier, CFGErrorNode, FunctionDef, SizeofOperand, AdditiveExpression, SwitchStatement, Decl, Label, Condition, InfiniteForNode, ClassDef, ExclusiveOrExpression, RelationalExpression, and ParameterList.

Edges from the abstract syntax tree are added to the code property graph 240 as either an IS_AST_PARENT edge, which provides the structure of the various language elements, or a DECLARES edge, which connects declaration statements to the declarations they contain.

A control flow graph is a representation, using graph notation, of all paths that might be traversed through a program during its execution. The control flow graph is used to add control flow information to the various nodes of the code property graph 240. This comes in the form of the FLOWS_TO edge which connects statement nodes to their successors, providing an overall ordering and flow to the nodes of the graph.

A program dependence graph is a representation, using graph notation, that makes data dependence and control dependence explicit. Control dependence is a relationship between two statements where one statement directly affects whether or not the other will be executed. Data dependence is a relationship between two statements whereby one statement has a dependence on a data element defined by another. The graph generation module 230 uses the program dependence graph to provide a significant amount of information pertaining to control dependence and data dependence between the elements in the code property graph 240. These two relationships are characterized by several different edge types in the code property graph 240. The DEF and USE edges connect statements to the nodes which they define and use respectively. This allows for a reachability analysis to be performed, which results in the REACHES edge type which connects the statements that are reached by data flow. In other words, this edge will connect the statements where the definition of a particular data element reaches another statement, and thus the latter is data dependent on the former. Similarly, the CONTROLS edge connects the statements which are control dependent on one another, meaning one statement directly controls whether or not the other will be executed. In both of the previous edge types, it is important to be able to determine all statements that must occur prior to a particular statement being reached. This is determined by building dominator and post-dominator trees inside the code property graph 240, represented by the edges DOM and POST DOM. These edges describe the dominance relationships between nodes of the graph which provide insight into which nodes must occur prior or subsequent to others.

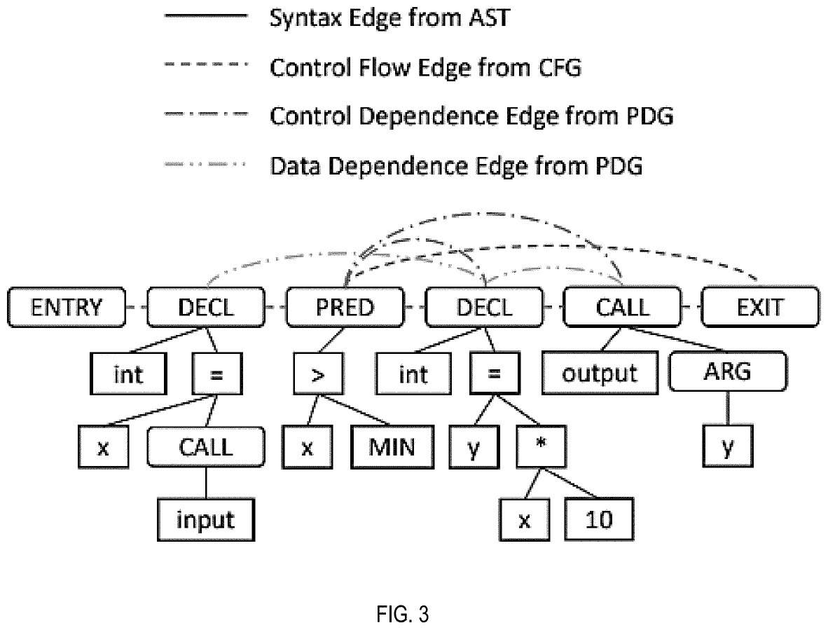

FIG. 3 illustrates an example code property graph 240 for the Code Segment 1 according to an exemplary embodiment.

As shown in FIG. 3, the abstract syntax tree provides the general syntactic structure of the source code, tokenizing each statement and categorizing them as declaration statements (DECL), call statements (CALL), predicate statements (PRED), etc. The control flow graph then provides an ordering to the abstract syntax tree elements, identifying all the possible logic traversal paths, such as the path from the predicate statement to the variable declaration, or the function exit. Finally, the program dependence graph provides information on control and data dependence between elements, such as the data dependence between the call to the output function and the previous variable declaration of y. The code property graph 240 allows the source code vulnerability detection system 200 to extract relationships between source code elements that would not be directly discernible based on the textual contents alone.

As described above, the graph generation module 230 generates code property graphs 240 of the vulnerable source code 222 (referred to in FIG. 2 as vulnerable code graphs 242) and the patched source code 224 (referred to in FIG. 2 as patched code graphs 244).

The source code vulnerability detection system 200 also identifies the overlapping elements in the vulnerable code graphs 242 and patched code graphs 244 so that key relationships between the vulnerable source code 222 and the patched source code 224 can be extracted. Specifically, the triplet sampling module 250 may convert the code property graphs 240 into code property triplets 260 of the form (Source, Relationship, Destination), where Source is a source node property, Destination is a destination node property, and Relationship is the type of edge between these two nodes as found in the code property graph 240. For each node in the code property graph 240, the triplet sampling module 250 extracts the code property triplets 260 as described in Algorithm 1:

Algorithm 1 Triplet Sampler
[Algorithm 1]

| | |
|---|---|
| 1: | procedure TRIPLET_SAMPLER(G) |

| | |
|---|---|
| 2: | triplets = [ ] |
| 3: | for n1 ∈ G.nodes do |

| | |
|---|---|
| 4: | for n2 ∈ G.neighbors(n1) do |

| | |
|---|---|
| 5: | for e ∈ G.edges(n1, n2) do |

| | |
|---|---|
| 6: | triplets.append(n1.code, e, n2.code) |
| 7: | triplets.append(n1.type, e, n2.code) |
| 8: | triplets.append(n1.code, e, n2.type) |
| 9: | triplets.append(n1.type, e, n2.type) |

| | |
|---|---|
| 10: | return triplets |

The triplet sampling module 250 typically generates four separate code property triplets 260, as seen in lines 6 through 9 of the Algorithm 1, for each edge in the code property graph 240. Line 6 generates a code property triplets 260 containing the textual source code contents. In some embodiments, the triplet sampling module 250 may stop there. However, that representation would not lend itself to type-2 and beyond code clones. Therefore, in preferred embodiments, the triplet sampling module 250 adds additional triplets with varying levels of abstraction. For example, in lines 7 and 8, the triplet sampling module 250 abstracts the source node and destination node respectively to their node types, rather than the textual contents. Finally, in line 9, the triplet sampling module 250 abstracts both nodes to their type representation.

By generating the code property triplets 260 in this manner, the source code vulnerability detection system 200 is able to not only capture the relationship between the textual contents of the source code 220, but also the more abstract relationships between types of statements in the source code 220. This way, even if a piece of source code 220 has textual modification, there will still be code property triplets 260 containing relevant information.

As described above, the triplet sampling module 250 extracts code property triplets 260 from the vulnerable code graphs 242 (referred to in FIG. 2 as vulnerable code property triplets 262) and the patched code graphs 244 (referred to in FIG. 2 as patched code property triplets 264).

The vulnerability graph generation module 270 generates vulnerability graphs 280 based on the set of vulnerable code property triplets 262 extracted from the vulnerable function of the vulnerable source code 222 and the patched code property triplets 264 extracted from the patched function of the patched source code 224. The vulnerability graphs 280 include positive triplets 282, negative triplets 284, and context triplets 286. The vulnerability graphs are stored in a vulnerability graph database in the storage media 140.

Positive triplets 282 are the code property triplets 260 from the vulnerable code graph 242 that are not found in the patched code graph 244. Intuitively, positive triplets 282 can be thought of as the specific relationships in the vulnerable code graph 242 that contributed to it being vulnerable. Note that this is not strictly textual modifications, as textual modification will result in additional changes to the graph structure, which is explicitly captured by this approach. Formally, the positive triplets PT can be defined as a function of the vulnerable code property triplets V and the patched code property triplets P as:

PT=V\P

Negative triplets 284 are the set of code property triplets 260 from the patched code graph 244 that are not found in the vulnerable code graph 242. Intuitively, the negative triplets 284 can be thought of as the specific relationships of the patched code graph 244 that contribute to it being patched to a particular vulnerability. Formally, negative triplets NT can be defined as a function of the patched code property triplets P and the vulnerable code property triplets V as:

NT=P\V

Context triplets 286 are the set of code property triplets 260 that are shared by both the vulnerable code graph 242 and the patched code graph 244. Intuitively, the context triplets 286 are the contextual relationships in the function that were not modified during the transition of the function from the vulnerable source code 222 to patched source code 224. As vulnerabilities are highly context dependent, this component is very important to represent the required context for the vulnerability to be present. Formally, context triplets CT can be defined as a function of the vulnerable code property triplets V and the patched code property triplets P as:

CT=V∩P

Combined, the positive triplets 282, the negative triplets 284, and the context triplets 286 represent a vulnerability graph 280 for a particular vulnerability. Table 1 provides a sample of the positive triplets 282, the negative triplets 284, and the context triplets 286 generated for Code Segment 1 (an example of a vulnerable source code 222) and Code Segment 2 (an example of a patched source code 224):

TABLE 1

| Positive Triplets 282 | Negative Triplets 284 | Context Triplets 286 |
|---|---|---|
| (x > MIN, CONTROLS, output(y)) | (y < MAX, CONTROLS, output(y)) | (x = input( ), DEF, x) |
| (y = x * 10, FLOWS_TO, output(y)) | (y = x * 10, FLOWS_TO, y < MAX)) | (y = x * 10, IS_AST_PARENT, x * 10) |
| (y = x * 10, FLOWS_TO, Expression) | (y = x * 10, FLOWS_TO, Condition) | (x = intput( ), REACHES, y = x * 10) |

From Table 1, it can be seen that the positive triplets 282 and the negative triplets 284 accurately capture key information as to what relationships between source code 220 elements are related to the function being identified as vulnerable vs. patched. In the first row, we can see that the positive triplet 282 and the negative triplet 284 capture the different control dependence relationships on the output(y) call, with the source code x>MIN controlling the output(y) call in the vulnerable source code 222, and y<MAX controlling the output(y) call in the patched source code 224. Similarly, in the second row, we can see that the positive triplet 282 and the negative triplet 284 capture the different control flow relationships that occur after the initialization of the y variable, with control flowing directly to the output(y) call in the vulnerable source code 222 and to the bounds check condition y<MAX in the patched source code 224. In the third row, we see a similar relationship to the second row for the positive triplet 282 and the negative triplet 284, however this time it is more abstract. The positive triplet 282 here represents control flow from the initialization of the variable y to any expression statement, and the negative triplet 284 to any condition statement. This is an accurate, yet much more abstract representation of a key relationship that contributes to the vulnerability determination.

Differently, in all rows of the context triplets 286 column, we can see various general contextual information of the function. The first row provides some information on how the variable x is defined based on the call to the input function. The second row provides some syntax-related context between the declaration for the variable y and the x*10 expression. The third row provides additional data dependence context between the declaration for y and the initialization of the variable x.

In the detection phase 208, the source code vulnerability detection system 200 determines whether target source code 178 from a target source 170 likely includes one of the vulnerabilities identified during the generation phase 202. The source code vulnerability detection system 200 uses many of the same modules as were used during the generation phase 202 as described above. For instance, the graph generation module 230 generates a target code graph 268 based on the target source code 178 using the same process to generate the vulnerable code graphs 242 and the patched code graphs. Additionally, the triplet sampling module 250 generates target triplets 288 based on the target code graph 268. Because the target source code 178 does not have a vulnerable and a patched version, all of the lines in the target source code 178 are reduced to a set of target triplets 288.

A triplet matcher 290 employs a triplet matching algorithm to compare the target triplets 288 generated based on the target source code 178 to each of the vulnerability graphs 280 stored in the vulnerability graph database. If a target source code 178 is a vulnerable code clone having a vulnerability represented by a specific vulnerability graph 260, then the target triplets 288 generated based on the target source code 178 are expected to have a number of characteristics. First, if many of the target triplets 288 are the same the context triplets 286 of the vulnerability graph 260, that is an indication that the target source code 178 may be a code clone of the vulnerable source code 222 having that vulnerability. Second, if many of the target triplets 288 are the same as the positive triplets 282 of that vulnerability graph 260, that is an indication that the target source code 178 may have the particular vulnerability represented by the vulnerability graph. Finally, if the target source code 178 shares few of the negative triplets 284 of the vulnerability graph 260, that is an indication that the target source code 178 may not have been patched.

Therefore, the triplet matcher 290 compares target triplets 288 generated based on target source code 178 received from target sources 170 to the positive triplets 282, negative triples 284, and the context triplets 286 identified for each vulnerability during the generation phase 202. To improve the ability to identify vulnerable code clones in the type-2 to type-4 range, the triplet matcher 290 may match the positive triplets 282 and the negative triplets 284 and the context triplets 286 independently and allow for some level of mismatch at each stage. For example, Algorithm 2 provides a pseudocode for an example triplet matching algorithm:

Algorithm 2 VGRAPH Vulnerability Detection
[Algorithm 2]

| | |
|---|---|
| 1: | procedure ISVULNERABLE(VGraph, target) |

| | |
|---|---|
| 2: | score_{C} = overlap(VGraph.CT, target) |
| 3: | if score_{C} > thresh_{C} then |

| | |
|---|---|
| 4: | score_{P} = overlap(VGraph.PT, target) |
| 5: | if score_{P} > thresh_{P} then |

| | |
|---|---|
| 6: | score_{N} = overlap(VGraph.NT, target) |
| 7: | if score_{N} < score_{P} then |

| | |
|---|---|
| 8: | return True |

| | |
|---|---|
| 9: | return False |

The example triplet matching algorithm takes as input vulnerability graph 280 (VGraph) as well as the target triplets 288 of an unknown target function and produces a binary result indicating if the particular target function is detected as a vulnerable code clone of the vulnerability represented by the vulnerability graph 280. The overlap function in the algorithm is a simple set overlap routine which returns the ratio of the query triplets (the positive triplets 282, the negative triplets 284, and the context triplets 286 of the vulnerability graph 280) found in the target triplets 288. The triplet matching algorithm may compare the number of overlapping triplets to thresholds. For example, threshC is a threshold used to compare the overlap between the target triplets 288 and the context triplets 286 and threshP is a threshold used to compare the overlap between the target triplets 288 and the positive triplets 286. Additionally or alternatively, triplet matching algorithm may compare the number of overlapping positive triplets 282, the number of overlapping negative triplets 284, and/or the number of overlapping positive triplets 286. For example, the example Algorithm 2 does not compare the overlap between the target triplets 288 and the negative triplets 284 to a threshold and instead compares the overlap between the target triplets 288 and the negative triplets 284 (score_{N}) to the overlap between the target triplets 288 and the positive triplets 284 (score_{P}).

As shown in Algorithm 2, the triplet matching algorithm may be very hierarchical nature. The triplet matching algorithm may first match against the context triplets 286 (as shown in line 2) and continue pursuing a match only if the overlap between the target triplets 288 and the negative triplets 286 (score_{C}) exceeds a threshold threshC (as shown line 3). Next, the triplet matching algorithm may first match against the positive triplets 282 (as shown in line 4) and continue pursuing a match one if the overlap between the target triplets 288 and the positive triplets 282 (score_{P}) exceeds a threshold threshP (as shown line 5). The triplet matching algorithm may perform the negative triplet matching (as shown in line 6). For example, if the overlap between the target triplets 288 and the negative triplets 284 (score_{N}) is less than the overlap between the target triplets 288 and the positive triplets 284 (score_{P}) as shown in line 7, then a true result will be returned (as shown in line 8), indicating that the target function in the target source code 178 is a vulnerable clone of the vulnerable source code 222. In all other cases, the function will return false, indicating that the target function in the target source code 178 is not a vulnerable clone of the vulnerable source code 222.

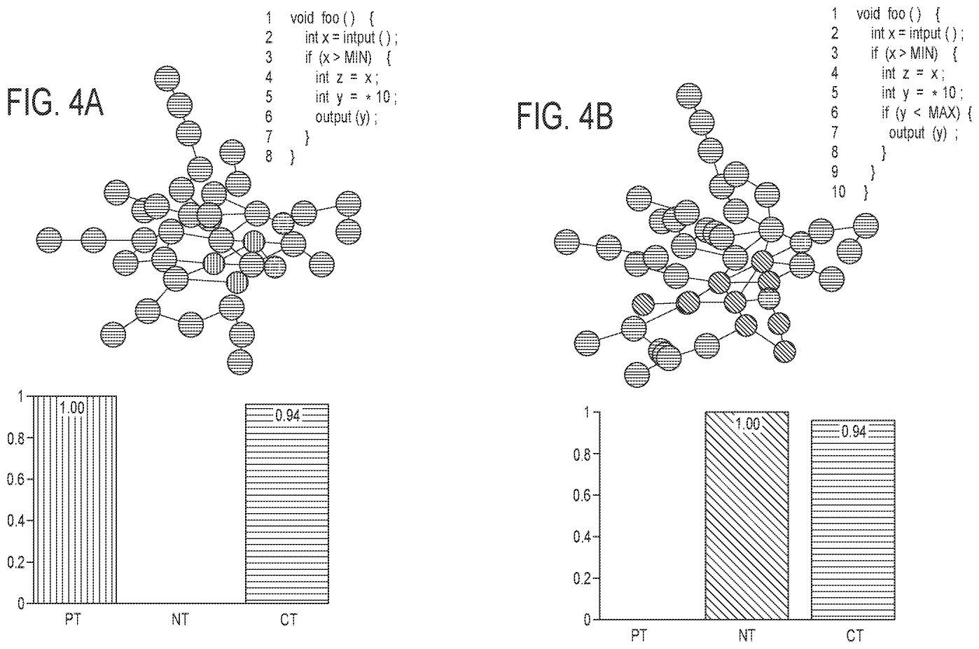

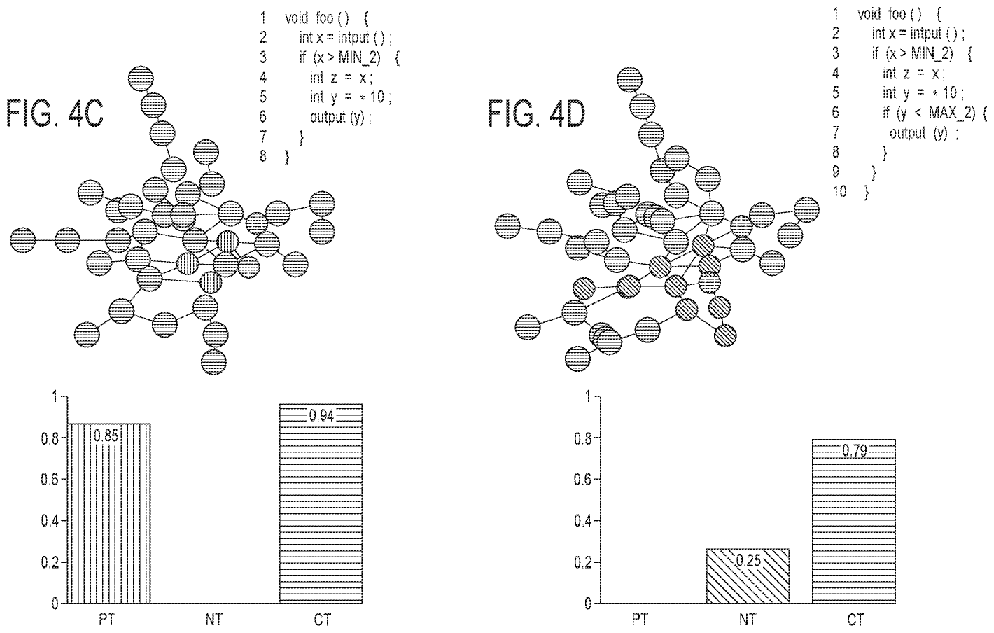

FIG. 4A and FIG. 4B show type-3 code clones of the original vulnerable source code 222 and patched source code 224, respectively. In both cases, a new variable declaration is made on line 4. We can see from the highlighted graph structure and the overlap scores, that the VGraph for the original vulnerability matches significantly differently against these two very similar functions. Despite the code modifications, all positive triplets 282 and none of the negative triplets 284 matched in the vulnerable function, and all of the negative triplets 284 and none of the positive triplets 282 matched in the patched function. This means, not only would the source code vulnerability detection system 200 be able to accurately detect these type-3 vulnerable and patched code clones, but also, there is significant room for additional modification to the function while still maintaining the ability to detect this vulnerability.

FIG. 4C and FIG. 4D illustrate another, more complex type-3 code clone pair. In the examples shown in FIGS. 4C and 4D, an additional type2 style modification to the variables is used in the critical bounds checks. The variable MIN has been replaced with MIN_2 in both the vulnerable and patched functions, and MAX with MAX_2 in the patched function. Despite this increase in modification, we can see that the source code vulnerability detection system 200 was again able to identify many of the critical elements of the vulnerability in the vulnerable clone, and none of them in the patched clone. There was significantly less negative triplet matching in this patched function. However, the NT score was still higher than the PT score, and the PT score was nearly 0%, indicating that the source code vulnerability detection system 200 would have properly labeled this function as not vulnerable.

In all four of the examples shown in FIGS. 4A-4D, the CT scores remained very high, indicating that the required context was present for these vulnerabilities to occur. This example shows that, with appropriate thresholding on the positive, negative, and context triplet overlap scores, the VGraph structure and triplet matching algorithm are able to accurately identify the vulnerable code clones, and, importantly, differentiate from their highly similar patched counterparts.

The foregoing description and drawings should be considered as illustrative only of the principles of the disclosure, which may be configured in a variety of shapes and sizes and is not intended to be limited by the embodiment herein described. Numerous applications of the disclosure will readily occur to those skilled in the art. Therefore, it is not desired to limit the disclosure to the specific examples disclosed or the exact construction and operation shown and described. Rather, all suitable modifications and equivalents may be resorted to, falling within the scope of the disclosure.

What is claimed is:

1. A method of determining whether target source code is likely to have a vulnerability, the method comprising:
identifying a vulnerable source code function having the vulnerability;
identifying a patched source code function representing the vulnerable source code function with the vulnerability having been patched;
generating a vulnerable code graph of the vulnerable source code function;
generating a patched code graph of the patched source code function;
converting the vulnerable code graph into vulnerable code property triplets;
converting the patched code property graph into patched code property triplets;
comparing the vulnerable code property triplets and the patched code property triplets to generate a vulnerability graph comprising:
positive triplets, found in the vulnerable code graph, that are not found in the patched code graph;
negative triplets, found in the patched code graph, that are not found in the vulnerable code graph; and
context triplets found in both the vulnerable code graph and the patched code graph;
generating a target code graph of the target source code;
converting the target code property graph into target triplets;
determining whether the target source code is likely to have the vulnerability by comparing the target triplets to the positive triplets, the negative triplets, and the context triplets.

2. The method of claim 1, wherein identifying the vulnerable source code function comprises:
searching log messages of a source code repository having a version control system and log messages to identify a log message referring to the vulnerability; and
identifying a vulnerable source code version prior to the log message referring to the vulnerability.

3. The method of claim 2, wherein identifying the patched source code function comprises identifying the patched source code version having the log message referring to the vulnerability.

4. The method of claim 3, wherein identifying the vulnerable source code function and identifying the patched source code function further comprises parsing the vulnerable source code version and the patched source code version to identify a function that was patched.

5. The method of claim 1, wherein generating each of the vulnerable code graph, the patched code graph, and the target code graph comprises:
generating an abstract syntax tree representing the abstract structure of the vulnerable source code function, the patched source code function, or the target source code; and
using the abstract syntax tree to identify a plurality of nodes, each node having a node property label identifying one of a plurality of node types, and directed edges between the nodes.

6. The method of claim 5, wherein generating each of the vulnerable code graph, the patched code graph, and the target code graph further comprises:
generating a flow control graph representing the paths that may be traversed during execution of the vulnerable source code function, the patched source code function, or the target source code;
using the flow control graph to add flow control information to the nodes of the code property graph;
generating a program dependence graph representing the program dependence and the control dependence of the vulnerable source code function, the patched source code function, or the target source code; and
using the program dependence graph add information regarding the program dependence and the control dependence to the code property graph.

7. The method of claim 1, wherein each of the vulnerable code property triplets, the patched code property triplets, and the target triplets include a source node, a destination node, and a relationship between the source node and the destination node.

8. The method of claim 1, further comprising:
storing a dataset of vulnerability graphs generated using a plurality of vulnerable source code functions having a plurality of vulnerabilities and a plurality of patched source code functions; and
determining whether the target source code is likely to have one of the plurality of vulnerabilities by comparing the target triplets generated using the target source code to the dataset of vulnerability graphs.

9. A graph-based source code vulnerability detection system, comprising:
a vulnerability mining module that:
identifies a vulnerable source code function having a vulnerability; and
identifies a patched source code function representing the vulnerable source code function with the vulnerability having been patched;
a graph generation module that:
generates a vulnerable code graph of the vulnerable source code function;
generates a patched code graph of the patched source code function; and
generates a target code graph of target source code;
a triplet sampling module that:
converts the vulnerable code graph into vulnerable code property triplets;
converts the patched code property graph into patched code property triplets; and
converts the target code property graph into target triplets;
a vulnerability graph generation module that compares the vulnerable code property triplets and the patched code property triplets to generate:
positive triplets, found in the vulnerable code graph, that are not found in the patched code graph;
negative triplets, found in the patched code graph, that are not found in the vulnerable code graph; and
context triplets found in both the vulnerable code graph and the patched code graph; and
a triplet matcher that determines whether the target source code is likely to have the vulnerability by comparing the target triplets to the positive triplets, the negative triplets, and the context triplets.

10. The system of claim 9, wherein the vulnerability mining module identifies the vulnerable source code function by:
searching log messages of a source code repository having a version control system and log messages to identify a log message referring to the vulnerability; and
identifying a vulnerable source code version prior to the log message referring to the vulnerability.

11. The system of claim 10, wherein the vulnerability mining module identifies the patched source code function by identifying the patched source code version having the log message referring to the vulnerability.

12. The system of claim 11, wherein the vulnerability mining module identifies the vulnerable source code function and the patched source code function further by parsing the vulnerable source code version and the patched source code version to identify a function that was patched.

13. The system of claim 9, wherein the graph generation module generates each of the vulnerable code graph, the patched code graph, and the target code graph by:
generating an abstract syntax tree representing the abstract structure of the vulnerable source code function, the patched source code function, or the target source code; and
using the abstract syntax tree to identify a plurality of nodes, each node having a node property label identifying one of a plurality of node types, and directed edges between the nodes.

14. The system of claim 13, wherein the graph generation module generates each of the vulnerable code graph, the patched code graph, and the target code graph further by:
generating a flow control graph representing the paths that may be traversed during execution of the vulnerable source code function, the patched source code function, or the target source code;
using the flow control graph to add flow control information to the nodes of the code property graph;
generating a program dependence graph representing the program dependence and the control dependence of the vulnerable source code function, the patched source code function, or the target source code; and
using the program dependence graph add information regarding the program dependence and the control dependence to the code property graph.

15. The system of claim 9, wherein each of the vulnerable code property triplets, the patched code property triplets, and the target triplets include a source node, a destination node, and a relationship between the source node and the destination node.

16. The system of claim 9, further comprising:
a database of vulnerability graphs generated using a plurality of vulnerable source code functions having a plurality of vulnerabilities and a plurality of patched source code functions,
wherein the triplet matcher determines whether the target source code is likely to have one of the plurality of vulnerabilities by comparing the target triplets generated using the target source code to the dataset of vulnerability graphs.

17. Non-transitory computer readable storage media (CRSM) storing instructions that, when executed by a computer processor, cause a graph-based source code vulnerability detection system to:
identify a vulnerable source code function having a vulnerability;
identify a patched source code function representing the vulnerable source code function with the vulnerability having been patched;
generate a vulnerable code graph of the vulnerable source code function;
generate a patched code graph of the patched source code function;
convert the vulnerable code graph into vulnerable code property triplets;
convert the patched code property graph into patched code property triplets;
compare the vulnerable code property triplets and the patched code property triplets to generate a vulnerability graph comprising:
positive triplets, found in the vulnerable code graph, that are not found in the patched code graph;
negative triplets, found in the patched code graph, that are not found in the vulnerable code graph; and
context triplets found in both the vulnerable code graph and the patched code graph;
generate a target code graph of target source code;
convert the target code property graph into target triplets;
determine whether the target source code is likely to have the vulnerability by comparing the target triplets to the positive triplets, the negative triplets, and the context triplets.

18. The CRSM of claim 17, wherein the instructions cause the system to generate each of the vulnerable code graph, the patched code graph, and the target code graph by:
generating an abstract syntax tree representing the abstract structure of the vulnerable source code function, the patched source code function, or the target source code;
using the abstract syntax tree to identify a plurality of nodes, each node having a node property label identifying one of a plurality of node types, and directed edges between the nodes;
generating a flow control graph representing the paths that may be traversed during execution of the vulnerable source code function, the patched source code function, or the target source code;
using the flow control graph to add flow control information to the nodes of the code property graph;
generating a program dependence graph representing the program dependence and the control dependence of the vulnerable source code function, the patched source code function, or the target source code; and
using the program dependence graph add information regarding the program dependence and the control dependence to the code property graph.

19. The CRSM of claim 17, wherein each of the vulnerable code property triplets, the patched code property triplets, and the target triplets include a source node, a destination node, and a relationship between the source node and the destination node.

20. The CRSM of claim 17, wherein the instructions further cause the system to determine whether the target source code is likely to have one of a plurality of vulnerabilities by comparing the target triplets generated using the target source code to a dataset of vulnerability graphs generated using a plurality of vulnerable source code functions having a plurality of vulnerabilities and a plurality of patched source code functions.
